(19) United States
(12) Patent Application Publication
(10) Pub. No.: US 2025/0053377 A1
(43) Pub. Date: Feb. 13, 2025

(54) METHOD AND SYSTEM FOR REMOVING NOISE FROM DIGITAL DATA

(71) Applicant: Raytheon Systems Limited, Harlow (GB)

(72) Inventors: Stewart A. Ritchie, Bridge of Earn (GB); Raymond F. Blane, Glenrothes (GB)

(21) Appl. No.: 18/799,417

(22) Filed: Aug. 9, 2024

(30) Foreign Application Priority Data
Aug. 9, 2023 (GB) 2312209.6
Jul. 25, 2024 (GB) 2410919.1

(51) Int. Cl. G06F 7/24; G06F 7/02; G06F 7/76

(52) U.S. Cl. CPC G06F 7/24; G06F 7/02; G06F 7/768

(57) ABSTRACT

A method includes obtaining N data elements; arranging the N data elements into a list; carrying out a series of N sorting cycles which alternate between a first sorting cycle and a second sorting cycle, wherein: in each first sorting cycle, numerical values of pairs of data elements in a first set of adjacent positions are compared, and the positions of the data elements in each pair are selectively swapped based on a result of the respective comparison; in each second sorting cycle, the numerical values of pairs of data elements in a second set of adjacent positions are compared, and the positions of the data elements in each pair are selectively swapped based on a result of the respective comparison; and the N data elements are arranged into an ordered list which is ordered in order of their numerical values; either: (i) outputting the data element, or the numerical value of the data element, in position (N+1)/2 if N is an odd number; or outputting an average of the numerical values of the data elements in positions N/2 and (N+1)/2 if N is an even number; or (ii) outputting an average of the numerical values of a group of data elements centred on a mid-point of the ordered list; and using the output as the median value of the N data elements.

### CROSS-REFERENCE TO RELATED APPLICATIONS AND PRIORITY CLAIM

This application claims priority under 35 U.S.C. § 119 to UK Patent Application No. 2312209.6 filed on Aug. 9, 2023 and to UK Patent Application No. 2410919.1 filed on Jul. 25, 2024, both of which are hereby incorporated by reference in their entirety.

### TECHNICAL FIELD

The present application relates to a method and system for removing noise from digital data, and in particular to a method and system for removing noise from digital data using a median filter.

### BACKGROUND

Information such as communications messages and information gathered by sensors is commonly transmitted, stored, and/or processed in the form of digital data, and it is a common problem that this digital data may comprise unwanted noise in addition to the desired information. As a result it is a common requirement to remove noise from the digital data. One approach for removing noise from digital data is to pass the digital data through a median filter.

One approach to providing a median filter is to sort a group of data elements of the digital data, where each data element has a numerical value, into an order based on their numerical values to identify which data element of the group of data elements has the median data value.

One known method of sorting data elements by numerical value is the Bubble Sort algorithm, also referred to as a sinking sort. The bubble sort algorithm is a comparison sort that repeatedly passes stepwise through an input list of data elements element by element, comparing the current element with the one after it, and swapping their values if needed to be in the desired order. These passes through the list are repeated until no swaps need to be performed during a pass, meaning that the list has become fully sorted into the desired value order. Although the bubble sort algorithm is straightforward, in practice it suffers from the problem that it can take large number of passes to complete the sorting, and as a result take a long time to complete the sorting, which can make it unsuitable for use in a median filter for noise removal in some time-sensitive applications. Further, this method of sorting can require an undesirably large amount of computing resources to provide a median filter for noise removal, leading to problems of excessive cost, weight and/or power consumption.

The inventors have devised the claimed invention in light of the above considerations. The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter; variants and alternative features which facilitate the working of the invention and/or serve to achieve a substantially similar technical effect should be considered as falling into the scope of the invention.

The invention is defined as set out in the appended set of claims.

In a first aspect of the present invention, there is provided a computer implemented method of removing noise from digital data by median filtering data elements of the digital data, the data elements comprising numerical values, the method comprising: obtaining N data elements, where N is an integer value greater than one; arranging the N data elements into a list with N positions 1 to N: carrying out a series of sorting cycles which alternate between a first sorting cycle and a second sorting cycle, wherein; in each first sorting cycle, the numerical values of pairs of data elements in a first set of adjacent positions are compared, and the positions of the data elements in each pair are selectively swapped, based on the result of the respective comparison; and in each second sorting cycle, the numerical values of pairs of data elements in a second set of adjacent positions are compared, the second set of adjacent positions being different from the first set of adjacent positions, and the positions of the data elements in each pair are selectively swapped, based on the result of the respective comparison; whereby the N data elements are arranged into an ordered list which is ordered in order of their numerical values; and either: if N is an odd number, outputting the data element, or the numerical value of the data element, in position (N+1)/2; or If N is an even number, outputting the average of the numerical values of the data elements in positions N/2 and (N+1)/2; or outputting the average of the numerical values of a group of data elements centred on the mid-point of the ordered list; and using the output as the median value of the N data elements. This may provide the advantages of quicker and more efficient and/or effective de-noising of the digital data.

In some embodiments, the series of sorting cycles comprises N sorting cycles. This may provide the advantage of more efficient de-noising by more efficient sorting of the data elements into an ordered list in a fixed time.

In some embodiments, if N is an odd number, the first set of adjacent positions comprises positions 2 to N but not position 1, and the second set of adjacent positions comprises positions 1 to N−1, but not position N; or if N is an even number, the first set of adjacent positions comprises positions 1 to N, and the second set of adjacent positions comprises positions 2 to N−1, but not positions 1 and N. This may provide the advantage of more efficient de-noising by quicker and more efficient sorting of the data elements into an ordered list.

In some embodiments, the method further comprising, when N is an even number, in at least some second sorting cycles, comparing the numerical values of the pair of data elements in positions 1 and N, and selectively swapping the positions of the data elements in positions 1 and N, based on the result of this comparison. This may provide the advantage of more efficient de-noising by quicker and more efficient sorting of the data elements into an ordered list.

In some embodiments, in each sorting cycle, for each comparison; if the data element in the lower numbered position has a larger numerical value than the data element in the higher numbered position, the positions of the two compared data elements are swapped; or, if the data element in the lower numbered position has a smaller numerical value than the data element in the higher numbered position, the positions of the two compared data elements are not swapped; whereby the data elements are arranged into an ordered list which is ordered in ascending order of their numerical values; or in each sorting cycle, for each comparison; if the data element in the lower numbered position has a smaller numerical value than the data element in the higher numbered position, the positions of the two compared data elements are swapped; or, if the data element in the lower numbered position has a larger numerical value than the data element in the higher numbered position, the positions of the two compared data elements are not swapped; arranged into an ordered list which is ordered in descending order of their numerical values. This may provide the advantage of more efficient de-noising by quicker and more efficient generating of an ordered list in ascending or descending order of numerical value.

In some embodiments, in each sorting cycle, for each comparison; if the data element in the lower numbered position has the same numerical value as the data element in the higher numbered position, the positions of the two compared data elements are not swapped. This may provide the advantage of improved efficiency.

In some embodiments, the first sorting cycle is carried out on each odd sorting cycle in the series, and the second sorting cycle is carried out on each even sorting cycle in the series; or the first sorting cycle is carried out on each even sorting cycle in the series, and the second sorting cycle is carried out on each odd sorting cycle in the series.

In some embodiments, in each sorting cycle all of the comparisons are carried out in parallel. This may provide the advantages of more efficient de-noising by quicker sorting of the data elements into an ordered list.

In some embodiments, the digital data is digital audio data or digital image data. This may provide the advantages of more efficient de-noising of the digital audio data or digital image data.

In some embodiments, the digital data is digital image data comprising: video image data or single image data from a camera or image capture device in at least one of the human visual frequency range band, the infrared (IR) band, the ultraviolet (UV) band, or the X-ray band; or radar data, sonar data, lidar data, X-ray data, or ultrasound scanning data; or computed tomography (CT) scanning data, computed axial tomography (CAT) scanning data, magnetic resonance imagery (MRI) scanning data, or positron emission tomography (PE) scanning data. This may provide the advantages of more efficient de-noising of the digital image data.

In some embodiments, the digital data is digital sensor data output from a digitizer, digital parameter data output from an analogue to digital converter (ADC), or digital communications data. This may provide the advantages of more efficient de-noising of the digital sensor data.

In some embodiments, the digital data is contaminated with impulse noise generated by a switched power supply and the output is used to regulate the switched power supply. This may provide the advantages of improved and/or more efficient control of the switched power supply.

In some embodiments, the digital data is digital video data and noise is removed from the digital video data by taking values of pixels surrounding a pixel, median filtering the values as data elements, and using the output to replace the pixel value of the pixel. This may provide the advantages of more efficient de-noising of the digital video data.

In a second aspect of the present invention, there is provided a system for removing noise from digital data by median filtering data elements of the digital data, the data elements comprising numerical values, the system comprising processing means arranged to: obtain N data elements, where N is an integer value greater than one; arrange the N data elements into a list with N positions 1 to N: carry out a series of sorting cycles which alternate between a first sorting cycle and a second sorting cycle, wherein; in each first sorting cycle, the numerical values of pairs of data elements in a first set of adjacent positions are compared, and the positions of the data elements in each pair are selectively swapped, based on the result of the respective comparison; and in each second sorting cycle, the numerical values of pairs of data elements in a second set of adjacent positions are compared, the second set of adjacent positions being different from the first set of adjacent positions, and the positions of the data elements in each pair are selectively swapped, based on the result of the respective comparison; whereby the N data elements are arranged into an ordered list which is ordered in order of their numerical values; and either: if N is an odd number, output the data element, or the numerical value of the data element, in position (N+1)/2; or if N is an even number, output the average of the numerical values of the data elements in positions N/2 and (N+1)/2; or output the average of the numerical values of a group of data elements centred on the mid-point of the ordered list; and use the output as the median value of the N data elements. This may provide the advantages of quicker and more efficient and/or effective de-noising of the digital data.

In some embodiments, the series of sorting cycles comprises N sorting cycles. This may provide the advantage of more efficient de-noising by more efficient sorting of the data elements into an ordered list in a fixed time.

In some embodiments, if N is an odd number, the first set of adjacent positions comprises positions 2 to N but not position 1, and the second set of adjacent positions comprises positions 1 to N−1, but not position N; or if N is an even number, the first set of adjacent positions comprises positions 1 to N, and the second set of adjacent positions comprises positions 2 to N−1, but not positions 1 and N. This may provide the advantage of more efficient de-noising by quicker and more efficient sorting of the data elements into an ordered list.

In some embodiments, the processing means are further arranged to, when N is an even number, in at least some second sorting cycles, comparing the numerical values of the pair of data elements in positions 1 and N, and selectively swapping the positions of the data elements in positions 1 and N, based on the result of this comparison. This may provide the advantage of more efficient de-noising by quicker and more efficient sorting of the data elements into an ordered list.

In some embodiments, in each sorting cycle, for each comparison; if the data element in the lower numbered position has a larger numerical value than the data element in the higher numbered position, the positions of the two compared data elements are swapped; or, if the data element in the lower numbered position has a smaller numerical value than the data element in the higher numbered position, the positions of the two compared data elements are not swapped; whereby the data elements are arranged into an ordered list which is ordered in ascending order of their numerical values; or in each sorting cycle, for each comparison; if the data element in the lower numbered position has a smaller numerical value than the data element in the higher numbered position, the positions of the two compared data elements are swapped; or, if the data element in the lower numbered position has a larger numerical value than the data element in the higher numbered position, the positions of the two compared data elements are not swapped; arranged into an ordered list which is ordered in descending order of their numerical values. This may provide the advantage of more efficient de-noising by quicker and more efficient generating of an ordered list in ascending or descending order of numerical value.

In some embodiments, in each sorting cycle, for each comparison; if the data element in the lower numbered position has the same numerical value as the data element in the higher numbered position, the positions of the two compared data elements are not swapped. This may provide the advantage of improved efficiency.

In some embodiments, the first sorting cycle is carried out on each odd sorting cycle in the series, and the second sorting cycle is carried out on each even sorting cycle in the series; the first sorting cycle is carried out on each even sorting cycle in the series, and the second sorting cycle is carried out on each odd sorting cycle in the series.

In some embodiments, the processing means is arranged to carry all of the comparisons in each sorting cycle in parallel. This may provide the advantages of more efficient de-noising by quicker sorting of the data elements into an ordered list.

In some embodiments, the processing means is a field programmable gate array (FPGA).

In some embodiments, the digital data is digital audio data or digital image data. This may provide the advantages of more efficient de-noising of the digital audio data or digital image data.

In some embodiments, the digital data is digital image data comprising: video image data or single image data from a camera or image capture device in at least one of the human visual frequency range band, the infrared (IR) band, the ultraviolet (UV) band, or the X-ray band; or radar data, sonar data, lidar data, X-ray data, or ultrasound scanning data; or computed tomography (CT) scanning data, computed axial tomography (CAT) scanning data, magnetic resonance imagery (MRI) scanning data, or positron emission tomography (PE) scanning data. This may provide the advantages of more efficient de-noising of the digital image data.

In some embodiments, the digital data is digital sensor data output from a digitizer, digital parameter data output from an analogue to digital converter (ADC), or digital communications data. This may provide the advantages of more efficient de-noising of the digital sensor data.

In some embodiments, the digital data is contaminated with impulse noise generated by a switched power supply and the output is used to regulate the switched power supply. This may provide the advantages of improved and/or more efficient control of the switched power supply.

In some embodiments, the digital data is digital video data and noise is removed from the digital video data by taking values of pixels surrounding a pixel, median filtering the values as data elements, and using the output to replace the pixel value of the pixel. This may provide the advantages of more efficient de-noising of the digital video data.

In a third aspect of the present invention, there is provided a computer-readable medium comprising instructions which, when executed by one or more processors, cause the one or more processor to carry out the method of the first aspect.

The features and embodiments discussed above may be combined as appropriate, as would be apparent to a person skilled in the art, and may be combined with any of the aspects of the invention except where it is expressly provided that such a combination is not possible or the person skilled in the art would understand that such a combination is self-evidently not possible.

### BRIEF DESCRIPTION OF THE DRAWINGS

Embodiments of the present invention are described below, by way of example, with reference to the following drawings.

FIG. 1 shows a schematic diagram of a known sequential bubble sort process;

FIG. 2 shows a schematic diagram of a noise removal system according to an embodiment;

FIG. 3 shows a schematic diagram of a median filter useable in the system of FIG. 2;

FIG. 4 is a schematic diagram of a first sorting method according to an embodiment;

FIG. 5 is a first worked example of the first sorting method of FIG. 3;

FIG. 6 is a first worked example of the first sorting method of FIG. 3;

FIG. 7 is a schematic diagram of a second sorting method according to an embodiment;

FIG. 8 is a worked example of the second sorting method of FIG. 6;

FIGS. 9A and 9B show an example of images produced using digital video image data with and without noise removal by the noise removal system of FIG. 2;

FIG. 10 shows an example illustrating a fixed phase delay produced by use of the noise removal system of FIG. 2; and

FIGS. 11A and 11B show another example of digital data with and without noise removal by the noise removal system of FIG. 2.

Common reference numerals are used throughout the figures to indicate the same or similar features.

### DETAILED DESCRIPTION

Embodiments of the present invention are described below by way of example only. These examples represent the best mode of putting the invention into practice that are currently known to the Applicant although they are not the only ways in which this could be achieved. the description sets forth the functions of the example and the sequence of steps for constructing and operating the example. However, the same or equivalent functions and sequences may be accomplished by different examples.

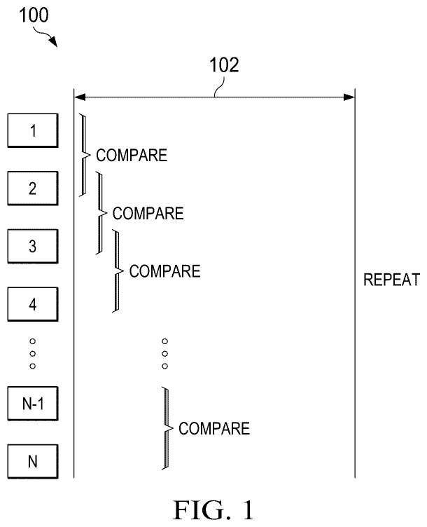

FIG. 1 shows a schematic explanatory diagram of a known sequential bubble sort process 100. The bubble sort process 100 operates on a list of data elements having numerical values, in the illustrated example N data elements, and sorts the list of data elements into order of numerical value. The bubble sort process 100 starts with the data elements at positions 1 to N in the list, and sorts the list of data elements into ascending order value from position 1 to position N by carrying out a series of passes across the list of data elements. A single pass 102 is shown in FIG. 1.

The pass 102 begins by comparing the values of the data elements in positions 1 and 2, if the value in position 1 is smaller than the value in position 2, no action is taken, but if the value in position 1 is larger than the value in position 2, the positions of the two data elements are swapped. This comparison and possible swapping is repeated in sequence for the data elements in positions 2 and 3, then the data elements in positions 3 and 4, and so on, until the data elements in positions N−1 and N are compared, and possibly swapped, and the pass 102 has been completed. The method repeats the passes 102 until a pass 102 is completed without any of the data elements being swapped. The list of data elements is then known to be arranged in ascending order of numerical value from position 1 to position N.

The bubble sort process is simple, but has the disadvantage that it is inefficient, requiring a large number of comparisons to execute, requiring N² comparisons, where N is the number of data elements being sorted. As is discussed in more detail below, there are a number of applications where noise removal from, or de-noising of, digital data using a median filter may be useful. However, the inefficiency of bubble sort may make it impractical for use in many applications, especially applications where digital data must be processed quickly in real time, or near real time. Noise removal, or de-noising, refers to the removal of at least some noise, and does not require the removal of all noise. Without wishing to be bound by theory, it is expected that in most application the complete removal of all noise will not be possible in practice. Noise removal or de-noising may also be referred to as noise reduction. In such applications, the noise reduced output digital data must be made available in good time for it to be used, and a median filter using a slow sorting algorithm, such as bubble sort, may be too slow, so that the delay in providing the noise reduced output digital data can render it unusable.

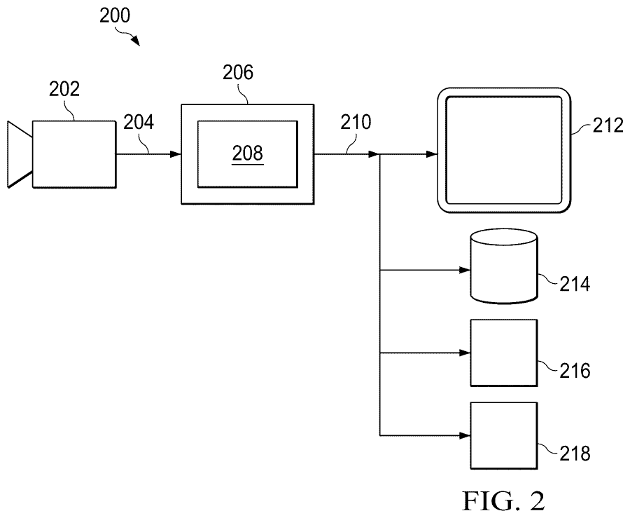

FIG. 2 is a schematic diagram of a digital video system 200 using a median filter to carry out noise removal. As shown in FIG. 2, the digital video system 200 comprises a video camera 202, or other video image capture device, producing digital video image data 204 and sending the digital video image data 204 to a noise reduction device 206 comprising a median filter 208. The noise reduction device 206 passes the digital video image data through the median filter to produce noise reduced digital video image data 210, and outputs the noise reduced digital video image data 210. The output noise reduced digital video image data 210 is then provided to one or more of a display device 212 for display to users, a data storage device 214 for storage for later use, a data processor 216 for processing, or to other devices 218, as required.

Digital video image data 204 can experience noise that manifests itself as incorrect pixel values leading to a poor quality image when the image is displayed, whether this display is immediate, or after storage and/or processing. Further, in examples where the digital video image data 204 is analysed, for example to identify features or properties of objects in the field of view of the video camera 202 the noise may reduce the accuracy and/or reliability of the analysis, even if no image derived from the digital video image data 204 is displayed in a human viewable form. The digital video image data 204 may comprise noise for a number of reasons, such as: electromagnetic interference (EMI) affecting the camera and/or the digital video image data 204 itself, thermal and other effects in the image sensing elements and/or other electronics of the video camera 202, fluctuations in the power supply to the video camera 202, and/or optical noise in the viewed field of view. It will be understood that this list of examples is not intended to be exhaustive.

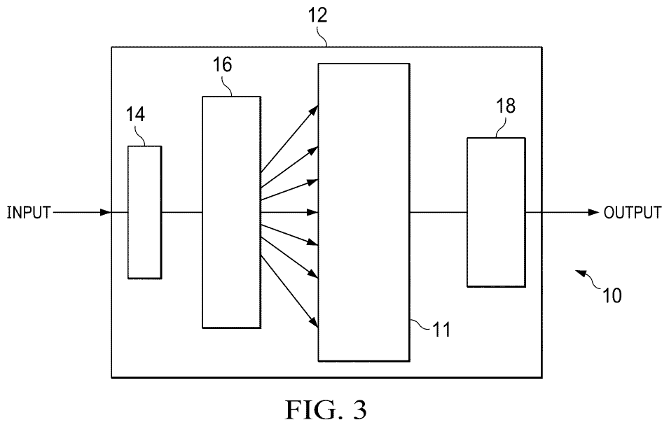

FIG. 3 is a schematic diagram of a median filter 10 which may be used as the median filter 208 of FIG. 2. The median filter 10 may be implemented in a Field Programmable gate Array (FPGA) 12 configured to carry out a sorting method to remove noise from digital data, according to a first embodiment. The sorting method may also be referred to as a sorting algorithm. In examples where the median filter 10 is used as the median filter 208 of FIG. 2 the digital data will be digital video image data.

The FPGA 12 implements the median filter 10 comprising a sorting module 11, a data input module 14, a memory or data storage module 16, and a median value output module 18. It will be understood that in practice the median filter 10 may comprise other components such as power supplies and the like, in addition to the FPGA 12.

The median filter 10 operates on a set of N data elements or data points comprising numerical values, where N is an integer greater than one, and determines the median value of the N data elements. The median filter 10 then outputs the determined median value. Accordingly, the median filter 10 outputs the median value of the set of N data elements and effectively rejects the largest and smallest values as erroneous. The number N of data elements in each set of N data elements and the method used to select the N data elements in each set may be selected as appropriate in any specific implementation of the median filter 10, for example based on the type and intended use of the filtered digital data.

In operation, the data input module 14 of the median filter 10 receives as inputs a set of N data elements, each comprising a numerical value, and stores the received data elements in the data storage module 16. In the illustrated example of FIG. 3 the data elements are received in series, in other examples the data elements may be received in parallel. When the data storage module 16 has a stored set of N data elements, the data storage module 16 transfers the set of N data elements to the sorting module 11 for sorting. In some examples where the data elements are received in series, the data storage module 16 may remove the oldest stored data element when each newly received data element is stored, operating in an analogous manner to a First In First Out (FIFO) memory, so that the stored set of N data elements always comprises the N most recently received data elements.

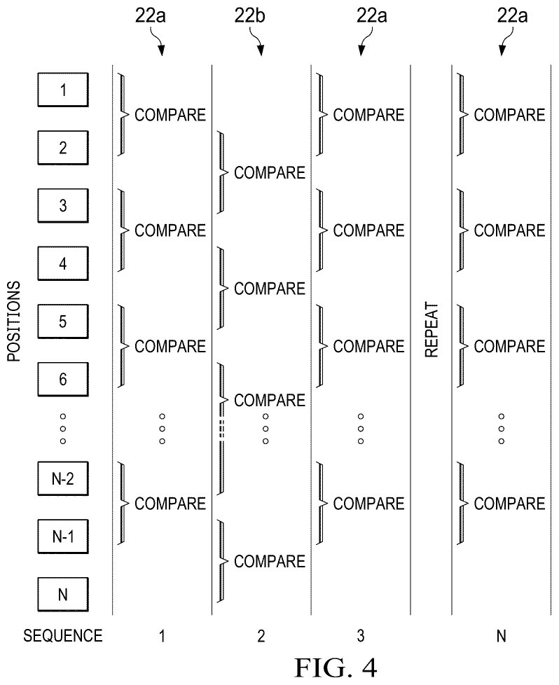

FIG. 4 is a schematic diagram of a first sorting method 20 used by the sorting module 11 in the first embodiment to sort a set of N data elements where N is an odd number, that is, an odd integer value greater than one.

As shown in FIG. 4, the first sorting method 20 operates on a set of N data elements, each comprising a numerical value, where N is an odd number. The set of N data elements may be regarded as a list with N entries or positions, which are numbered from 1 to N in the illustrated example. The objective of the first sorting method 20 is to sort the set of N data elements into an ordered list in numerical value order. In the illustrated example of FIG. 4 the first sorting method 20 sorts the N data elements into an ordered list in ascending numerical value order so that the data element at position 1 has the smallest (or lowest) numerical value and the data element at position N has the largest (or highest) numerical value.

The first sorting method 20 comprises a sequence of sorting cycles cycles 22, which comprise alternate first sorting cycles 22a and second sorting cycles 22b.

The first sorting method 20 first arranges the N data elements into a list with positions 1 to N.

In first sorting cycles 22a of the first sorting method 20, starting with the sequentially first sorting cycle 22, the sorting module 11 compares the numerical values of the data elements in positions 1 and 2, compares the numerical values of the data elements in positions 3 and 4, compares the numerical values of the data elements in positions 5 and 6, and so on, up to and including comparing the numerical values of the data elements in positions N−2 and N−1. Thus, the numerical values of the data elements in pairs of adjacent positions in a first set of adjacent positions 1 to N−1 are compared in the first sorting cycles 22a, whereby a total of (N−1)/2 comparisons are carried out, and each data element, with the exception of the data element in position N, is compared to one other data element. The data element in position N is not used in any comparison in first sorting cycles 22a.

All of the comparisons are carried out simultaneously in parallel, by different elements of the FPGA 12 implementing the sorting module 11. For each comparison, if the data element in the lower numbered position has a smaller numerical value than the data element in the higher numbered position, or if both elements have the same value, no action is taken (that is, the positions of the two compared data elements are not swapped), and if the data element in the lower numbered position has a larger numerical value than the data element in the higher numbered position, the positions of the two compared data elements are swapped.

Then, in second comparison cycles 22b of the first sorting method 20, starting with the sequentially second sorting cycle 22, the sorting module 11 compares the numerical values of the data elements in positions 2 and 3, compares the numerical values of the data elements in positions 4 and 5, compares the numerical values of the data elements in positions 6 and 7, and so on, up to and including comparing the numerical values of the data elements in positions N−1 and N. Thus, the numerical values of the data elements in pairs of adjacent positions in a second set of adjacent positions 2 to N are compared in the second sorting cycles 22b, whereby a total of (N−1)/2 comparisons are carried out, and each data element, with the exception of the data element in position 1, is compared to one other data element. The data element in position 1 is not used in any comparison in second sorting cycles 22b. It will be understood from the above that the second set of adjacent positions is different from the first set of adjacent positions.

In the same way as in the first sorting cycles 22a, all of these comparisons are carried out simultaneously, in parallel, by different elements of the FPGA 12, and for each comparison, if the data element in the lower numbered position has a smaller numerical value that the data element in the higher numbered position, or if both elements have the same value, no action is taken (that is, the positions of the two compared data elements are not swapped), and if the data element in the lower numbered position has a larger numerical value than the data element in the higher numbered position, the positions of the two compared data elements are swapped.

The sorting module 11 then alternately repeats the first sorting cycles 22a and the second sorting cycles 22b until the sequentially Nth sorting cycle has been completed. It will be understood that because N is an odd number, the sequentially Nth sorting cycle will always be the same type of sorting cycle as the sequentially first sorting cycle 22, in the illustrated example a first sorting cycle 22a. On completion of the Nth sorting cycle, the first sorting method 20 ends, and the N data elements will be arranged in an ordered list in ascending numerical value order so that the data element at position 1 has the smallest numerical value and the data element at position N has the largest numerical value.

Thus, when the Nth sorting cycle has been completed, and the first sorting method 20 has ended, the N data elements are arranged in an ordered list in numerical value order. In the illustrated example, ascending numerical value order, so that the data element at position 1 has the smallest numerical value and the data element at position N has the largest numerical value. The sorting module 11 then provides the data element in the position number (N+1)/2, or the numerical value of that data element, to the median value output module 18. The numerical value of this data element in position number (N+1)/2 is the median numerical value of the set of N data elements.

The median value output module 18 then outputs the median numerical value of the set of N data elements as the output of the median filter 10. As is explained above, this is the numerical value of the data element in position number (N+1)/2 after the Nth sorting cycle. The output of the median filter 10 can then be used to provide the noise reduced digital video image data 210.

As is explained above, the first method 20 will produce an ordered list after carrying out (N−1)/2 comparisons on each of N cycles, for a total of N ((N−1)/2) comparison operations, where N is the number of data elements processed. This will take a time period equal to N times the period required for a single comparison operation. In contrast, a conventional bubble sort will take N² consecutive comparison operations to produce an ordered list, which will take a time period equal to N² times the period required for a single comparison operation. Accordingly, the disclosed first method will produce an ordered list both more quickly, and with fewer comparison operations in total, than a convention bubble sort. This may provide advantages of allowing sorting, for example in a median filter to provide a median value for use in removing noise, to be carried out quickly enough to be used in time critical applications where the use of a conventional bubble sort based median filter for removing noise would not be possible, and may also reduce the amount of computing resources required to carry out the sorting part of the noise removal. Accordingly, the present invention may provide the advantage of a significant reduction in processing time to reject the outlier data. This may, for example, allow larger filters (that is, a higher value of N) to be used in applications which are more sensitive to time delays, providing better filtering and better noise removal. In the illustrated embodiment the different comparisons in each sorting cycle are carried out in parallel. However, even if the different comparisons were to be carried out sequentially, for example in a single processor such as a Central Processing Unit (CPU), the first method will still be quicker than a conventional bubble sort, although slower than the disclosed parallel implementation. Further, the first method 20 produces a sorted list within a fixed maximum time, and so can be implemented to produce a fixed delay, which may be advantageous in some applications. Although the illustrated embodiment provides a median value for use in removing noise, the method can be used in any application where fast determination of a median value from a set of data values is required, and so may be useful in any application where a fast ordering of a set of data values is required.

In illustrated embodiment of FIGS. 3 and 4, the first sorting method is used in a median filter. In alternative examples, the first sorting method may be used for other purposes. In such examples, some other part, or all of, the sorted ordered list may be output instead of the numerical value of the data element in position number (N+1)/2.

In the illustrated example of FIG. 4 the first sorting method 20 starts with a first sorting cycle 22a as the sequentially first sorting cycle 22₁. In other examples, the first sorting method could instead start with a second sorting cycle 22b as the sequentially first sorting cycle 22₁, provided that first sorting cycles 22a and second sorting cycles 22b are carried out alternately.

In the illustrated example of FIG. 4 the first sorting method 20 sorts the N data elements into an ordered list in ascending numerical value order so that the data element at position 1 has the smallest numerical value and the data element at position N has the largest numerical value. If desired, the first sorting method could be reversed to sort the N data elements into an ordered list in descending numerical value order so that the data element at position 1 has the largest numerical value and the data element at position N has the smallest numerical value. To do this, in each comparison, if the data element in the higher numbered position has a smaller numerical value that the data element in the lower numbered position, or if both elements have the same value, no action is taken, and if the data element in the higher numbered position has a larger numerical value than the data element in the lower numbered position, the positions of the two compared data elements are swapped. It should be noted that in this alternative example, similarly to the illustrated example, on completion of the first sorting method the numerical value of the data element in position number (N+1)/2 is the median numerical value of the set of N data elements. Further, the produced N data elements in an ordered list can be used to provide an ordered list in either ascending or descending order as required simply by changing the order in which the data elements in the different positions are read or output between a 1 to N order and an N to 1 order.

In the illustrated embodiment of FIG. 3 the comparisons of the numerical values of the different pairs of data elements are carried out in parallel by the FPGA 12. In alternative examples the comparisons of the numerical values of the different pairs of data elements may be carried out in parallel by other computing elements. In such examples, each comparison may be carried out by a separate computing element, for example, by a separate processor or a plurality of processors, or by different cores of one or more multi-core processors.

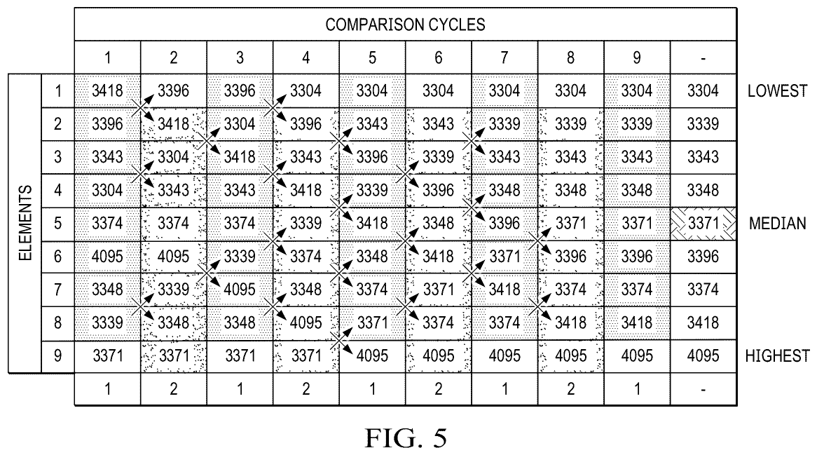

FIG. 5 is an illustrative worked example of the first sorting method 20. In the illustrated example of FIG. 4 N has a value of 9, so that there are nine data elements, and each data element comprises a four-digit numerical value. Similarly to the illustrated example of FIG. 4, in FIG. 5 the first sorting method 20 sorts the N data elements into an ordered list in ascending numerical value order so that the data element at position 1 has the smallest numerical value and the data element at position N has the largest numerical value. The first sorting method 20 comprises N sorting cycles 22₁ to 22_{N}, in the illustrated example 22₁ to 22₉.

In the first (in sequence) sorting cycle 22₁, which is a first sorting cycle 22a, the numerical values of the pairs of adjacent data elements in positions 1 and 2, positions 3 and 4, positions 5 and 6, and positions 7 and 8, are compared. The data element in position 9 (that is, position N) is not involved in a comparison in a first sorting cycle 22a. As shown in FIG. 4, the data element in position 1 has the numerical value 3418, which is larger than the numerical value 3396 of the data element in position 2, so the positions of these two data elements are swapped. Similarly, the positions of the data elements in positions 3 and 4, and the data elements in positions 7 and 8 are swapped. In contrast, the data element in position 5 has the numerical value 3374, which is smaller than the numerical value 4095 of the data element in position 6, so that no action is taken, and the positions of these two data elements are not swapped.

Then, in the second (in sequence) sorting cycle 222, which is a second sorting cycle 22b, numerical values of the pairs of adjacent data elements in positions 2 and 3, positions 4 and 5, positions 6 and 7, and positions 8 and 9, are compared. The data element in position 1 is not involved in a comparison in a second sorting cycle 22b. As shown in FIG. 4, the data element now in position 2 has the numerical value 3418, which is larger than the numerical value 3304 of the data element now in position 3, so the positions of these two data elements are swapped. Similarly, the positions of the data elements now in positions 6 and 7 are swapped. In contrast, the data element now in position 4 has the numerical value 3343, which is smaller than the numerical value 3374 of the data element now in position 5, so that no action is taken, and the positions of these two data elements are not swapped. Similarly, the positions of the data elements in positions 8 and 9 are not swapped.

The method then continues for third to ninth (that is, third to Nth) sorting cycles 223 to 22₉, alternating between first sorting cycles 22a and second sorting cycles 22b, where the ninth sorting cycle 22₉ is the Nth and final sorting cycle. On completion of the ninth sorting cycle the nine data elements are arranged in an ordered list in ascending numerical value order so that the data element at position 1 has the smallest numerical value.

The first method 20 is certain to produce an ordered list in numerical value order on completion of the Nth sorting cycle, that is, the ninth sorting cycle in the illustrated example of FIG. 4. However, it is possible that the initial arrangement of the data elements may be such that the first method 20 arrives at the desired ordered list before this. For example, in the illustrated example of FIG. 4 it can be seen that the set of nine data elements are arranged in the desired ordered list with the data element at position I having the largest numerical value and the data element at position 9 having the smallest numerical value at the completion of the seventh sorting cycle, and that as a result, there is no change in the order of the data elements in the eighth or ninth sorting cycles.

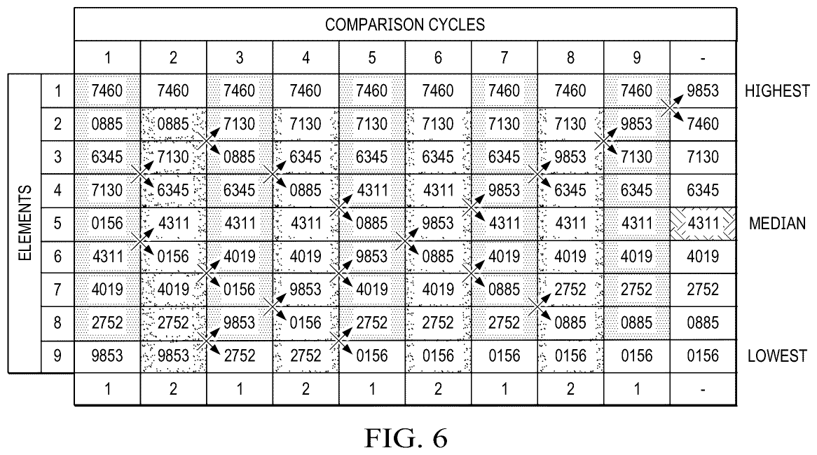

FIG. 6 is a further illustrative worked example of the first sorting method 20. In the illustrated example of FIG. 6 N has a value of 9, so that there are nine data elements, and each data element comprises a four-digit numerical value. In FIG. 5 the first sorting method 20 sorts the N data elements into an ordered list in descending numerical value order so that the data element at position 1 has the largest numerical value and the data element at position N has the smallest numerical value. In FIG. 5 the first sorting method 20 comprises N sorting cycles 22₁ to 22_{N}, in the illustrated example 22₁ to 22₉. As can be seen in FIG. 6, in the example of FIG. 6 nine (N) sorting cycles are required to arrive at the desired ordered list. Although the first method 20 may arrive at the desired ordered list before the Nth sorting cycle, the first method 20 is certain to arrive at the desired ordered list by (that is, on or before) completion of the Nth sorting cycle.

In the illustrated examples of FIGS. 4 to 6, the first sorting method 20 compares the numerical values of data elements in positions 1 to N−1 in first sorting cycles 22a in odd numbered sorting cycles, and compares the numerical values of data elements in positions 2 to N in second sorting cycles 22b in even numbered sorting cycles. This arrangement of odd and even cycles is not essential. If desired the sorting method could reverse this, and instead compare the numerical values of data elements in positions 1 to N−1 in first sorting cycles 22a in even numbered sorting cycles, and compare the numerical values of data elements in positions 2 to N in second sorting cycles 22b in odd numbered sorting cycles. This would have no effect on the results of the first sorting method.

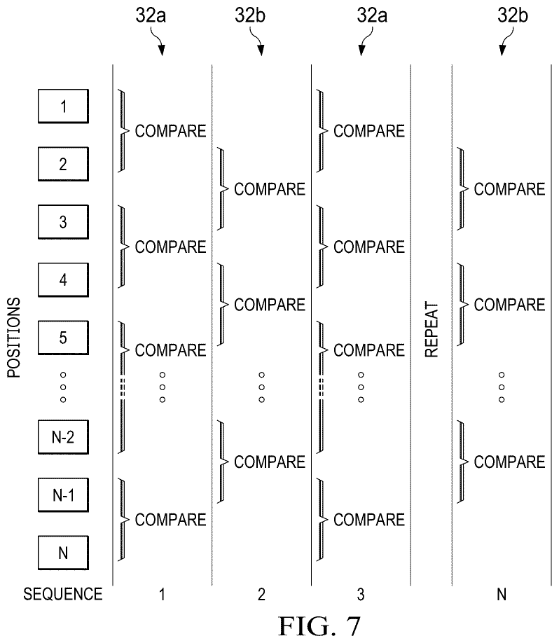

FIG. 7 is a schematic diagram of a second sorting method 30 used by the sorting module 11 in a second embodiment to sort a set of N data elements where N is an even number, that is, an even integer value greater than one. In contrast, the first sorting method of FIGS. 4 to 6 operates on a set of N data elements, each comprising a numerical value, where N is an odd number.

As shown in FIG. 7, the second sorting method 30 operates on a set of N data elements, each comprising a numerical value, where N is an even number. Similarly to the first sorting method 20, the set of N data elements may be regarded as a list with N entries or positions, which are numbered from 1 to N in the illustrated example, and the objective of the second sorting method 30 is to sort the set of N data elements into an ordered list in numerical value order. In the illustrated example of FIG. 7 the second sorting method 30 sorts the N data elements into an ordered list in ascending numerical value order so that the data element at position 1 has the smallest (or lowest) numerical value and the data element at position N has the largest (or highest) numerical value.

The second sorting method 30 first arranges the N data elements into a list with positions 1 to N.

The second sorting method 30 comprises a sequence of sorting cycles 32, which comprise alternate first sorting cycles 32a and second sorting cycles 32b. In first sorting cycles 32a of the second sorting method 30, starting with the sequentially first sorting cycle 32 in the illustrated example, the sorting module 11 compares the numerical values of the data elements in positions 1 and 2, compares the numerical values of the data elements in positions 3 and 4, compares the numerical values of the data elements in positions 5 and 6, and so on, up to and including comparing the numerical values of the data elements in positions N−1 and N. Thus, the numerical values of the data elements in pairs of adjacent positions in a first set of adjacent positions 1 to N are compared in the first sorting cycles 32a, whereby a total of N/2 comparisons are carried out, and each data element is compared to one other data element.

In the second sorting method 30, similarly to the first sorting method 20, all of the comparisons are carried out simultaneously in parallel, by different elements of the FPGA 12 implementing the sorting module 11. For each comparison, if the data element in the lower numbered position has a smaller numerical value than the data element in the higher numbered position, or if both elements have the same value, no action is taken (that is, the positions of the two compared data elements are not swapped), and if the data element in the lower numbered position has a larger numerical value than the data element in the higher numbered position, the positions of the two compared data elements are swapped.

Then, in second sorting cycles 32b of the second sorting method 30, starting with the sequentially second sorting cycle 32 in the illustrated example, the sorting module 11 compares the numerical values of the data elements in positions 2 and 3, compares the numerical values of the data elements in positions 4 and 5, compares the numerical values of the data elements in positions 6 and 7, and so on, up to and including comparing the numerical values of the data elements in positions N−2 and N−1. Thus, the numerical values of the data elements in pairs of adjacent positions in a second set of adjacent positions 2 to N−1 are compared in the second sorting cycles 32b, whereby a total of (N−2)/2 comparisons are carried out, and each data element, with the exception of the data elements in positions 1 and N, is compared to one other data element. The data elements in position 1 and N are not used in any comparison in the second sorting cycles 32b. It will be understood from the above that the second set of adjacent positions is different from the first set of adjacent positions.

In the same way as in the first sorting cycles 32a, all of these comparisons are carried out simultaneously, in parallel, by different elements of the FPGA 12, and for each comparison, if the data element in the lower numbered position has a smaller numerical value that the data element in the higher numbered position, or if both elements have the same value, no action is taken (that is, the positions of the two compared data elements are not swapped), and if the data element in the lower numbered position has a larger numerical value than the data element in the higher numbered position, the positions of the two compared data elements are swapped.

The sorting module 11 then alternately repeats the first sorting cycles 32a and the second sorting cycles 32b until the sequentially Nth sorting cycle has been completed. It will be understood that because N is an even number, the sequentially Nth sorting cycle will always be the same type of sorting cycle as the sequentially second sorting cycle 32, in the illustrated example a second sorting cycle 32b. On completion of the Nth sorting cycle, the second sorting method 30 ends, and the N data elements will be arranged in an ordered list in ascending numerical value order so that the data element at position 1 has the smallest numerical value and the data element at position N has the largest numerical value.

Thus, when the Nth sorting cycle has been completed, and the second sorting method 30 has ended, the N data elements are arranged in an ordered list in numerical value order. In the illustrated example, ascending numerical value order, so that the data element at position 1 has the smallest numerical value and the data element at position N has the largest numerical value. The sorting module 11 then provides the data elements in the position numbers N/2 and (N/2)+1, or the numerical value of those data element, to the median value output module 18. The average value of these two data elements in positions numbers N/2 and (N/2)+1 is the median numerical value of the set of N data elements.

The median value output module 18 then calculates the average value of the data elements in the position numbers N/2 and (N/2)+1, and outputs this average value, which is the median numerical value of the set of N data elements, as the output of the median filter 10.

As is explained above, the second method 30 will produce an ordered list after alternately carrying out either N/2 or (N−2)/2 comparisons on each of N cycles, where N is the number of data elements processed. This will take a time period equal to N times the period required for a single comparison operation. In contrast, a conventional bubble sort will take N² consecutive comparison operations to produce an ordered list, which will take a time period equal to N² times the period required for a single comparison operation. Accordingly, similarly to the first method, the disclosed second method will produce an ordered list both more quickly, and with fewer comparison operations in total, than a convention bubble sort, and will provide the same advantages when used for noise reduction.

In illustrated embodiment of FIGS. 3 and 7, the second sorting method is used in a median filter. In alternative examples, the second sorting method may be used for other purposes. In such examples, some other part, or all of, the sorted ordered list may be output instead of the numerical value of the data elements in positions numbers N/2 and (N/2)+1.

In the illustrated example of FIG. 7 the second sorting method 30 sorts the N data elements into an ordered list in ascending numerical value order so that the data element at position 1 has the smallest numerical value and the data element at position N has the largest numerical value. If desired, the second sorting method could be reversed to sort the N data elements into an ordered list in descending numerical value order so that the data element at position 1 has the largest numerical value and the data element at position N has the smallest numerical value. To do this, in each comparison, if the data element in the higher numbered position has a smaller numerical value that the data element in the lower numbered position, or if both elements have the same value, no action is taken, and if the data element in the higher numbered position has a larger numerical value than the data element in the lower numbered position, the positions of the two compared data elements are swapped.

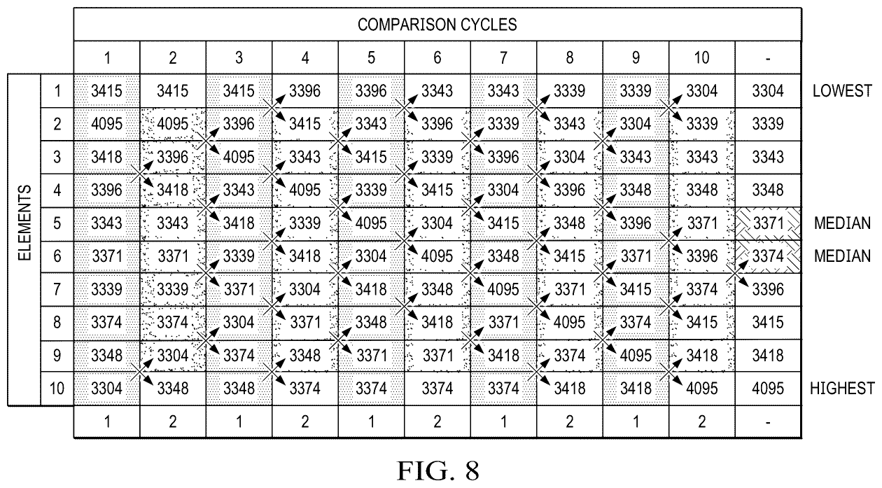

FIG. 8 is an illustrative worked example of the second sorting method 30. In the illustrated example of FIG. 7 N has a value of 10, so that there are ten data elements, and each data element comprises a four-digit numerical value. Similarly to the illustrated example of FIG. 7, in FIG. 7 the second sorting method 30 sorts the N data elements into an ordered list in ascending numerical value order so that the data element at position 1 has the smallest numerical value and the data element at position N has the largest numerical value. The second sorting method 30 comprises N sorting cycles 32₁ to 32_{N}, in the illustrated example 32₁ to 32₁₀.

In the first (in sequence) sorting cycle 32₁, which is a first sorting cycle 32a, the numerical values of the pairs of data elements in positions 1 and 2, positions 3 and 4, positions 5 and 6, positions 7 and 8, and position 9 and 10, are compared. As shown in FIG. 7, the data element in position 3 has a larger numerical value than the data element in position 4, so the positions of these two data elements are swapped. Similarly, the positions of the data elements in positions 9 and 10 are swapped. In contrast, the data element in position 1 has a smaller numerical value than the data element in position 2, so that no action is taken, and the positions of these two data elements are not swapped. Similarly, the data elements in positions 5 and 6, and positions 7 and 8 are also not swapped.

Then, in the second (in sequence) sorting cycle 32₂, which is a second sorting cycle 32b, numerical values of the pairs of data elements in positions 2 and 3, positions 4 and 5, positions 6 and 7, and positions 8 and 9, are compared. The data elements in positions 1 and 10 are not involved in a comparison in a second sorting cycle 32b. As shown in FIG. 7, the data element now in position 2 has a larger numerical value than the data element now in position 3, so the positions of these two data elements are swapped. Similarly, the positions of the data elements now in positions 4 and 5, positions 6 and 7, and positions 8 and 9 are swapped. In the illustrated example, all of the compared pairs of data elements are swapped.

The method then continues for third to tenth (that is, third to Nth) sorting cycles 32₃ to 32₁₀, alternating between first sorting cycles 32a and second sorting cycles 32b, where the tenth sorting cycle 32₁₀ is the Nth and final sorting cycle. On completion of the tenth sorting cycle the ten data elements are arranged in an ordered list in ascending numerical value order so that the data element at position 1 has the smallest numerical value.

The second method 30 is certain to produce an ordered list in numerical value order on completion of the Nth sorting cycle, that is, the tenth sorting cycle in the illustrated example of FIG. 7. However, it is possible that the initial arrangement of the data elements may be such that the second method 30 arrives at the desired ordered list before this. Similarly to the first method 20, although the third method 30 may arrive at the desired ordered list before the Nth sorting cycle, the second method 30 is certain to arrive at the desired ordered list by (that is, on or before) completion of the Nth sorting cycle.

In the illustrated example of FIG. 8 the two data elements in the position numbers N/2 and (N/2)+1, that is, position numbers 5 and 6 are provided to the median value output module 18. The median value output module 18 then outputs the average value of these two data elements as the median value of the set of N data elements, in the illustrated example 3372.5.

In the illustrated example of FIGS. 7 and 8, the second sorting method 30 compares the numerical values of data elements in positions 1 to N in first sorting cycles 32a in odd numbered sorting cycles, and compares the numerical values of data elements in positions 2 to N−1 in second sorting cycles 32b in even numbered sorting cycles. This arrangement of odd and even cycles is not essential. If desired the sorting method could reverse this, and instead compare the numerical values of data elements in positions 1 to N in first sorting cycles 32a in even numbered sorting cycles, and compare the numerical values of data elements in positions 2 to N−1 in second sorting cycles 32b in odd numbered sorting cycles. This would have no effect on the results of the second sorting method.

In the illustrated example of FIGS. 7 and 8, the second sorting method 30 compares the numerical values of data elements in positions 1 to N in first sorting cycles 32a, and compares the numerical values of data elements in positions 2 to N−1 in second sorting cycles 32b.

This arrangement of odd and even cycles is not essential. If desired the sorting method could reverse this, and instead compare the numerical values of data elements in positions 1 to N in first sorting cycles 32a in even numbered sorting cycles, and compare the numerical values of data elements in positions 2 to N−1 in second sorting cycles 32b in odd numbered sorting cycles. This would have no effect on the results of the second sorting method.

The second sorting method 30, comprises second sorting cycles 32b in which the numerical values of the data elements in pairs of adjacent positions in the second set of adjacent positions 2 to N−1 are compared, and the data elements in positions 1 and N are not used in any comparison. Optionally, in some examples, the second sorting method 30 may be extended to additionally compare the numerical values of the data elements in positions 1 and N to one another, even though these positions are not adjacent. In such examples, when the second sorting method 30 is intended to sort the N data elements into an ordered list in ascending numerical value order, if the data element in position 1 (the lower numbered position) has a smaller numerical value that the data element in position N (the higher numbered position), or if both elements have the same value, no action is taken (that is, the positions of the two compared data elements are not swapped), and if the data element in position I has a larger numerical value than the data element in the position N, the positions of the two compared data elements are swapped. Alternatively, in such examples, when the second sorting method 30 is intended to sort the N data elements into an ordered list in descending numerical value order, if the data element in position 1 (the lower numbered position) has a larger numerical value that the data element in position N (the higher numbered position), or if both elements have the same value, no action is taken (that is, the positions of the two compared data elements are not swapped), and if the data element in position 1 has a smaller numerical value than the data element in the position N, the positions of the two compared data elements are swapped. This optional extension to additionally compare the numerical values of the data elements in positions 1 and N to one another may be carried out in all second sorting cycles, or may be carried out only in some second sorting cycles. Without wishing to be bound by theory, it may be preferred to only carry out this additional comparison in early second sorting cycles of the second sorting method 30 because it is unlikely that the relative values of the data elements in positions 1 and N could be such that they would be swapped later in the second sorting method 30. This extension may improve the sorting efficiency.

In the illustrated embodiments the first and second sorting methods 20 and 30 are continued for N sorting cycles 22 or 32, whereby the set of data elements are definitely arranged into the desired ordered list on completion of the Nth sorting cycle. In principle, in alternative examples, the set of data elements could be checked to see if they are in the desired ordered list during the methods 20 or 30, for example by ending the methods 20 or 30 early if a sorting cycle is carried out without any data elements being swapped. Additional checking logic may be provided to check whether the set of data elements is in the desired ordered list. However, without wishing to be bound by theory, it is expected that the added complexity of this alternative will not usually be considered worthwhile. In many applications, provided that the desired ordered list, and any median value produced based on the ordered list, can always be produced within a required time period, there is no particular benefit to sometimes producing the ordered list, and any median value, more quickly and earlier within the required time period.

In the illustrated example of FIGS. 5 and 6 the numerical value of the data element in position number (N+1)/2 is output as the median value of the set of N data elements, while in the example of FIG. 8 the two data elements in the position numbers N/2 and (N/2)+1, that is, position numbers 5 and 6 are provided to the median value output module 18 and the average value of these two data elements is output as the median value of the set of N data elements. In alternative examples, the average value of a group of data elements centred on the mid-point of the ordered list may be output as the median value. For example, in the example of FIGS. 5 and 6 the average value of the group of three data elements in position numbers ((N+1)/2)−1, (N+1)/2 and ((N+1)/2)+1, or in the example of FIG. 8 the group of four data elements in position numbers (N/2)−1, N/2, (N/2)+1 and (N/2)+2. In other examples, groups of different sizes may be used. For example, where N is an odd number, the average value of an odd numbered group of data elements in adjacent positions having an equal number of data elements above position number (N+1)/2 and below position number (N+1)/2 may be output as the median value. In some examples, where N is an odd number, the average value of an odd numbered group of data elements in adjacent positions having an equal number of data elements above position number (N+1)/2 and below position number (N+1)/2 may be output as the median value. In other examples, where N is an even number, the average value of an even numbered group of data elements in adjacent positions having an equal number of data elements at and below position number (N+1)/2 and at and above position number ((N+1)/2)+1 may be output as the median value.

In the illustrated examples a noise removal system comprising a median filter is used to remove noise from digital video data. As discussed above, digital video can experience noise that manifests itself as incorrect pixel values leading to a poor quality image. One method of filtering the image is to examine the pixels around a pixel and replace it with the median value. For example the values of the pixels in a 3×3 matrix could be filtered by a median filter according to the present invention, replacing the centre pixel by the median value. In other examples different approaches may be used.

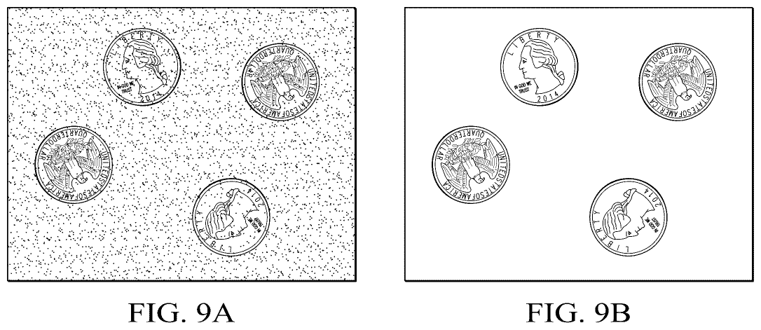

FIG. 9A shows an example of a digital video image with some noise. FIG. 9B shows a same digital video image after the digital video image data has been filtered by a noise removal system comprising a median filter according to the present invention to remove noise. As can be seen in FIGS. 9A and 9B, the filtered video image is less noisy. However, the median filter also results in a softening of the edge detail in the video image, so there is a trade-off to be made that balances the level of noise reduction against the level of distortion caused to the video image, that is governed by the size of the median filter (that is, the size of the pixel matrix).

In the illustrated examples above the noise removal system comprising a median filter is used to remove or reduce noise in digital video image data from a video camera or image capture device. The video camera or image capture device may be a conventional video camera operating to capture images in the human visual frequency range band, but can also operate at other frequency range bands such as the infrared (IR) band and ultraviolet (UV) band, or the X-ray band. In some examples the system may be further arranged to display the reduced noise image.

In some examples, the noise removal system comprising a median filter may be used to remove or reduce noise from digital image data comprising other types of two or three dimensional image data such as video image data or single image data from a camera or image capture device in the human visual frequency range band, or other frequency range bands such as the infrared (IR) band and ultraviolet (UV) band, or the X-ray band, radar data, sonar data, lidar data, X-ray data, or ultrasound scanning data. Typical applications of radar digital data include air traffic control, autonomous driving, weather detection and/or forecasting, navigation, and targeting and guidance. Typical applications of lidar data include autonomous driving, weather detection and/or forecasting, navigation, targeting and guidance, and virtual reality applications. Typical applications of sonar data include underwater mapping, navigation, targeting and guidance. Typical applications of X-ray data and ultrasound scanning include medical, veterinary and engineering applications. These lists of typical applications are not intended to be exhaustive.

In further examples the noise removal system comprising a median filter may be used to remove or reduce noise from digital image data comprising other types of two or three dimensional image data such as computed tomography (CT) scanning data, computed axial tomography (CAT) scanning data, magnetic resonance imagery (MRI) scanning data, or positron emission tomography (PE) scanning data. Typically, digital data of this type is used in medical applications. This list is not intended to be exhaustive.

In further examples the noise removal system comprising a median filter may be used to remove or reduce noise from digital image data comprising audio data. In some examples the system may be further arranged to produce the reduced noise audio as a sound output.

There are a number of applications where the noise removal system comprising a median filter can be used to filter digital data to remove noise, and it is important that the noise removal including the filtering is reliably carried out within a predetermined time. One example is the use of a noise removal system comprising a median filter to remove noise from digital data which is contaminated with impulse noise generated by a switched power supply. Typically, switched power supplies use switching by transistors turning on and off at high frequencies to generate a desired power waveform, and the switching on and off of these transistors, or other switches, generates impulse noise. This impulse noise can reduce the quality of digital voltage measurements used in digital control techniques used to regulate the power supply, and this can significantly affect the operation of digital control loops used to control the switch transistors to produce the desired power waveform. For example, the digital data may be voltage and/or current measurements of the generated power waveform which are used in a feedback loop to control the switching of the switched power supply generating the power waveform.

Accordingly, it is necessary to filter the digital voltage data before use. Low Pass filtering can be used but this can introduce a varying delay that negatively affects the control loop operation. The noise removal system comprising a median filter according to the present invention is superb at rejecting impulse noise while only introducing a fixed phase delay. It will be understood that the fixed delay of the first method corresponds to a fixed phase delay when used in a noise removal system comprising a median filter.

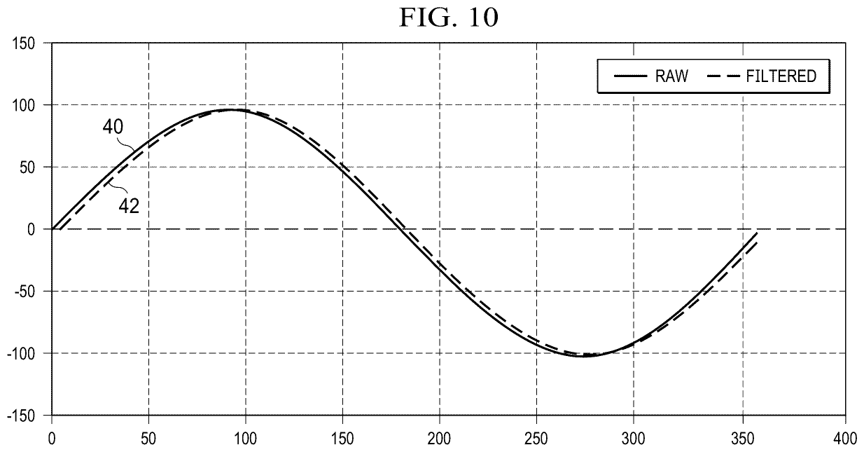

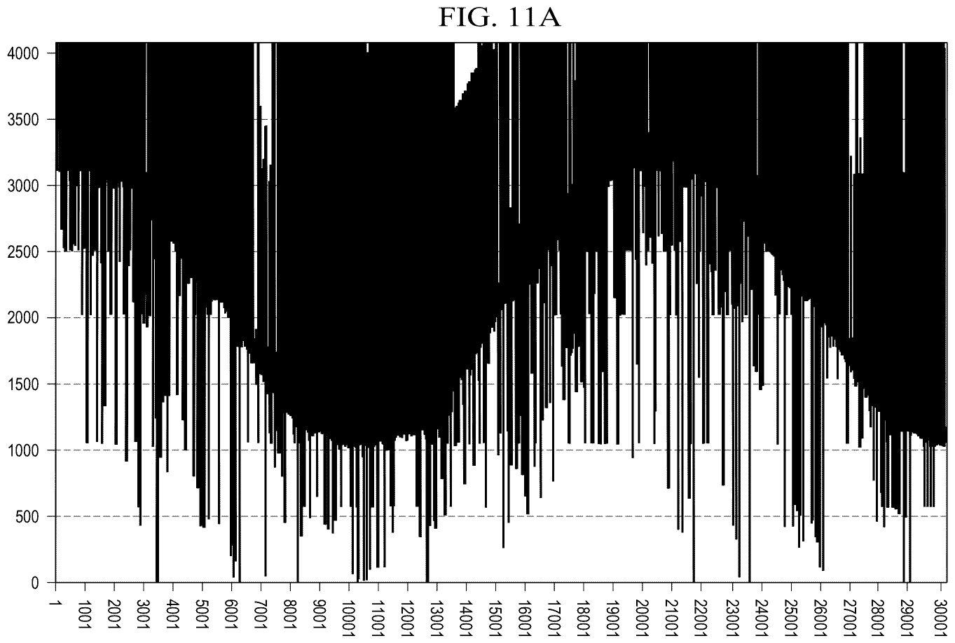

FIG. 10 shows a diagram of the respective values over time of a raw digital signal 40 and a corresponding filtered digital signal 42, which filtered digital signal 42 is produced by filtering the raw digital signal 40 to remove noise by a noise removal system comprising a median filter according to the illustrated embodiment of FIGS. 2 and 3. As can be seen in FIG. 10, the values of the filtered digital signal 42 are delayed relative to the corresponding values of the raw digital signal 40 by a fixed time delay. This fixed time delay substantially corresponds to the fixed time taken to carry out the sorting method of the present disclosure as part of the operation of the noise removal system comprising a median filter of FIGS. 2 and 3, together with some minor communication and data transfer delays, which are also substantially fixed.

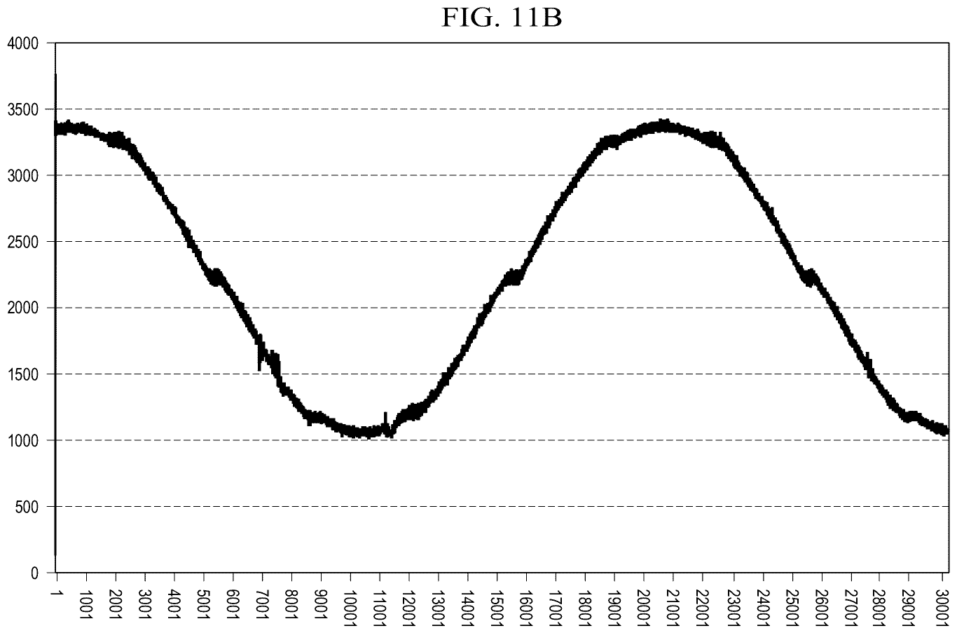

FIG. 11A shows an example of an example of raw captured digital voltage data for a signal that is heavily contaminated with impulse noise. FIG. 11B shows the same digital voltage data after being filtered to remove noise by a noise removal system comprising a median filter according to the present invention. As can be seen in FIGS. 11A and 11B, the noise removed median filtered data is much less noisy.

In further examples the noise removal system comprising a median filter can be used to filter digital data comprising digital sensor data output from a digitizer. Digitizers are used in instrumentation for measurement and/or sensing, and typical applications include oscilloscopes, spectrum and/or network analysers, and high speed data recorders.

In further examples the noise removal system comprising a median filter can be used to filter digital data comprising digital parameter data output from an analogue to digital converter (ADC) such as a high speed ADC.

In further examples the noise removal system comprising a median filter can be used to filter digital data comprising digital communications data. Typical digital communications applications where this may be desirable include satellite communications, software defined radio (SDR) and anti-jamming of satellite positioning system signals, such as global positioning system (GPS) signals to increase resistance to jamming. This list is not intended to be exhaustive.

In the illustrated embodiments, the entire median filter 10 is implemented in an FPGA 12. In alternative examples, only a part of the median filter 10 may be implemented in the FPGA while other parts are implemented separately, including by one or more further FPGA(s). In some such examples the sorting module 11 only may be implemented in the FPGA.

In the illustrated embodiments, the median filter 10 is implemented in an FPGA 12. In other alternative examples, the median filter 10 and/or the sorting module 11 may be implemented as a processor based architecture, for example in a Graphics Processing Unit (GPU), a Complex Programmable Logic Device (CPLD), or a Programmable Logic Controller (PIC) with integrated logic. Such a processor based architecture may provide speed benefits in operating the median filter 10 and/or the sorting module 11.

In the illustrated embodiments, in each comparison, if both data elements have the same numerical value, no action is taken. This is not essential, and as an alternative, the data elements could instead be exchanged when both data elements have the same numerical value. However, without wishing to be bound by theory, it is expected that this alternative will be a less efficient use of computing resources because of the additional exchanges. Further, since such an “exchange” of two identical numerical values will not result in any change in the data elements, such an “exchange” may be regarded as taking no action.

The embodiments described above are fully automatic. In some alternative examples a user or operator of the system may manually instruct some steps of the method to be carried out.

The acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously. This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is issued for designing silicon chips, or for configuring universal programmable chips, to carry out desired functions.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray (RTM) disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

Further, to the extent that the term “includes” is used in either the detailed description or the claims, such term is intended to be inclusive in a manner similar to the term “comprising” as “comprising” is interpreted when employed as a transitional word in a claim.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A computer-implemented method of removing noise from digital data by median filtering data elements of the digital data, the data elements comprising numerical values, the method comprising:
obtaining N data elements, where N is an integer value greater than one;
arranging the N data elements into a list with N positions 1 to N;
carrying out a series of sorting cycles which alternate between a first sorting cycle and a second sorting cycle, wherein:
in each first sorting cycle, the numerical values of pairs of data elements in a first set of adjacent positions are compared, and the positions of the data elements in each pair are selectively swapped based on a result of the respective comparison;
in each second sorting cycle, the numerical values of pairs of data elements in a second set of adjacent positions are compared, the second set of adjacent positions being different from the first set of adjacent positions, and the positions of the data elements in each pair are selectively swapped based on a result of the respective comparison; and
the N data elements are arranged into an ordered list which is ordered in order of their numerical values;
either:
outputting the data element, or the numerical value of the data element, in position (N+1)/2 if N is an odd number; or outputting an average of the numerical values of the data elements in positions N/2 and (N+1)/2 if N is an even number; or
outputting an average of the numerical values of a group of data elements centred on a mid-point of the ordered list; and
using the output as a median value of the N data elements.

2. The method of claim 1, wherein the series of sorting cycles comprises N sorting cycles.

3. The method of claim 1, wherein one of:
if N is an odd number, the first set of adjacent positions comprises positions 2 to N but not position 1, and the second set of adjacent positions comprises positions 1 to N−1 but not position N; or
if N is an even number, the first set of adjacent positions comprises positions 1 to N, and the second set of adjacent positions comprises positions 2 to N−1 but not positions 1 and N.

4. The method of claim 3, further comprising:
when N is an even number, in at least some second sorting cycles, comparing the numerical values of the pair of data elements in positions 1 and N, and selectively swapping the positions of the data elements in positions 1 and N based on a result of this comparison.

5. The method of claim 1, wherein, in each sorting cycle, for each comparison, either:
if the data element in a lower numbered position has a larger numerical value than the data element in a higher numbered position, the positions of the two compared data elements are swapped; or, if the data element in the lower numbered position has a smaller numerical value than the data element in the higher numbered position, the positions of the two compared data elements are not swapped; wherein the data elements are arranged into an ordered list which is ordered in ascending order of their numerical values; or
if the data element in the lower numbered position has a smaller numerical value than the data element in the higher numbered position, the positions of the two compared data elements are swapped; or, if the data element in the lower numbered position has a larger numerical value than the data element in the higher numbered position, the positions of the two compared data elements are not swapped; wherein the data elements are arranged into an ordered list which is ordered in descending order of their numerical values.

6. The method of claim 5, wherein, in each sorting cycle, for each comparison, if the data element in the lower numbered position has a same numerical value as the data element in the higher numbered position, the positions of the two compared data elements are not swapped.

7. The method of claim 1, wherein either:
the first sorting cycle is carried out on each odd sorting cycle in the series, and the second sorting cycle is carried out on each even sorting cycle in the series; or
the first sorting cycle is carried out on each even sorting cycle in the series, and the second sorting cycle is carried out on each odd sorting cycle in the series.

8. The method of claim 1, wherein the digital data is digital audio data or digital image data.

9. The method of claim 8, wherein the digital data is digital image data comprising:
video image data or single image data from a camera or image capture device in at least one of a human visual frequency range band, an infrared (IR) band, an ultraviolet (UV) band, or an X-ray band;
radar data, sonar data, lidar data, X-ray data, or ultrasound scanning data; or
computed tomography (CT) scanning data, computed axial tomography (CAT) scanning data, magnetic resonance imagery (MRI) scanning data, or positron emission tomography (PE) scanning data.

10. The method of claim 1, wherein the digital data is digital sensor data output from a digitizer, digital parameter data output from an analogue to digital converter (ADC), or digital communications data.

11. The method of claim 1, wherein the digital data is contaminated with impulse noise generated by a switched power supply and the output is used to regulate the switched power supply.

12. The method of claim 1, wherein the digital data is digital video data and the noise is removed from the digital video data by taking values of pixels surrounding a specified pixel, median filtering the values as data elements, and using the output to replace a pixel value of the specified pixel.

13. A system for removing noise from digital data by median filtering data elements of the digital data, the data elements comprising numerical values, the system comprising:
one or more processors configured to:
obtain N data elements, where N is an integer value greater than one;
arrange the N data elements into a list with N positions 1 to N;
carry out a series of sorting cycles which alternate between a first sorting cycle and a second sorting cycle, wherein:
in each first sorting cycle, the numerical values of pairs of data elements in a first set of adjacent positions are compared, and the positions of the data elements in each pair are selectively swapped based on a result of the respective comparison;
in each second sorting cycle, the numerical values of pairs of data elements in a second set of adjacent positions are compared, the second set of adjacent positions being different from the first set of adjacent positions, and the positions of the data elements in each pair are selectively swapped based on a result of the respective comparison; and
the N data elements are arranged into an ordered list which is ordered in order of their numerical values;
either:
output the data element, or the numerical value of the data element, in position (N+1)/2 if N is an odd number; or output an average of the numerical values of the data elements in positions N/2 and (N+1)/2 if N is an even number; or
output an average of the numerical values of a group of data elements centred on a mid-point of the ordered list; and
use the output as a median value of the N data elements.

14. The system of claim 13, wherein the series of sorting cycles comprises N sorting cycles.

15. The system of claim 13, wherein one of:
if N is an odd number, the first set of adjacent positions comprises positions 2 to N but not position 1, and the second set of adjacent positions comprises positions 1 to N−1 but not position N; or
if N is an even number, the first set of adjacent positions comprises positions 1 to N, and the second set of adjacent positions comprises positions 2 to N−1 but not positions 1 and N.

16. The system of claim 13, wherein the one or more processors are further configured, when N is an even number, in at least some second sorting cycles, to compare the numerical values of the pair of data elements in positions 1 and N, and selectively swap the positions of the data elements in positions 1 and N based on a result of this comparison.

17. The system of claim 13, wherein, in each sorting cycle, for each comparison, the one or more processors are configured to either:
if the data element in a lower numbered position has a larger numerical value than the data element in a higher numbered position, swap the positions of the two compared data elements; or, if the data element in the lower numbered position has a smaller numerical value than the data element in the higher numbered position, not swap the positions of the two compared data elements; wherein the data elements are arranged into an ordered list which is ordered in ascending order of their numerical values; or
if the data element in the lower numbered position has a smaller numerical value than the data element in the higher numbered position, swap the positions of the two compared data elements; or, if the data element in the lower numbered position has a larger numerical value than the data element in the higher numbered position, not swap the positions of the two compared data elements; wherein the data elements are arranged into an ordered list which is ordered in descending order of their numerical values.

18. The system of claim 17, wherein, in each sorting cycle, for each comparison, if the data element in the lower numbered position has a same numerical value as the data element in the higher numbered position, the positions of the two compared data elements are not swapped.

19. The system of claim 13, wherein the one or more processors are further configured to either:
carry out the first sorting cycle on each odd sorting cycle in the series, and carry out the second sorting cycle on each even sorting cycle in the series; or
carry out the first sorting cycle on each even sorting cycle in the series, and carry out the second sorting cycle on each odd sorting cycle in the series.

20. A non-transitory computer-readable medium comprising instructions for removing noise from digital data by median filtering data elements of the digital data, the data elements comprising numerical values, wherein the instructions, when executed by one or more processors, cause the one or more processor to:
obtain N data elements, where N is an integer value greater than one;
arrange the N data elements into a list with N positions 1 to N;
carry out a series of sorting cycles which alternate between a first sorting cycle and a second sorting cycle, wherein:
in each first sorting cycle, the numerical values of pairs of data elements in a first set of adjacent positions are compared, and the positions of the data elements in each pair are selectively swapped based on a result of the respective comparison;
in each second sorting cycle, the numerical values of pairs of data elements in a second set of adjacent positions are compared, the second set of adjacent positions being different from the first set of adjacent positions, and the positions of the data elements in each pair are selectively swapped based on a result of the respective comparison; and
the N data elements are arranged into an ordered list which is ordered in order of their numerical values;
either:
output the data element, or the numerical value of the data element, in position (N+1)/2 if N is an odd number; or output an average of the numerical values of the data elements in positions N/2 and (N+1)/2 if N is an even number; or
output an average of the numerical values of a group of data elements centred on a mid-point of the ordered list; and
use the output as a median value of the N data elements.
